(19) United States
(12) Patent Application Publication
(10) Pub. No.: US 2007/0156624 A1
(43) Pub. Date: Jul. 5, 2007

(54) System and method of patient specific vital sign estimation

(76) Inventor: Mark Daniel Palma, Fitchburg, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/324,505

(22) Filed: Jan. 3, 2006

(51) Int. Cl. G06N 5/04

(52) U.S. Cl. 706/60

(57) ABSTRACT

The system and method of patient specific vital sign estimation of the present invention includes an expert system having multiple parameters, equations and rules (expert rules) derived by medical experts. Influencing factors for a specific patient are entered in to the expert system, and expert system calculates an estimated blood pressure range, heart rate range, or any other desired medical parameter range based on the influencing factors and the expert rules. These estimated ranges are used to set a maximum and minimum alarm value on a monitor. The system and method is further configured to include in the expert system an additional set of expert rules to calculate estimated ranges when the patient is under anesthetic.

### FIELD OF THE INVENTION

The present invention is related to the field of patient monitoring. More specifically, the present invention is related to the field of vital sign limit estimation in patient monitoring.

### BACKGROUND OF THE INVENTION

Currently, systems are used to monitor a patient's vital signs such as blood pressure, heart rate, temperature, and other physiologic variables during surgery. These systems include alarms for parameters, such as blood pressure and heart rate that are out of range. The high and low threshold ranges are currently selectable by the user. However, there is a great deal of variability from patient to patient for parameter value ranges which are normal for a specific patient.

For example, children age 1-10 years old have a normal resting heart rate in the range of 60-140 bpm, whereas a well-conditioned adult athlete has a normal resting range of 40-60 bpm. Therefore, a resting value of 120 bpm is normal for a 5 year old, but very abnormal for the athlete. Another example is that a normal variation of a woman's blood pressure is that it is higher during pregnancy.

Many factors influence what is a normal heart rate or blood pressure for an individual, including age, gender, weight, height, physical condition, medications, and medical conditions or history. Because of this variability, it is not possible to set a single set of heart rate, or blood pressure, or any other physiologic parameter alarm range that is appropriate for all patients. The user of the monitor must manually adjust the alarm limits to be appropriate for the individual patient, or disable or ignore the alarms.

There is a need for the estimation of patient specific parameter values for both simple threshold based alarms and advanced multi-parameter smart alarms during surgery/anesthesia. Although physicians are able to make estimates for these values based on patient age, gender, height, weight, physical condition, medications, medical conditions/history, and anesthesia used, they are very busy with many tasks already, and they generally do not have the time to manually adjust alarm parameters for every patient/surgical case.

### SUMMARY OF THE INVENTION

The system and method of patient specific vital sign estimation of the present invention includes an expert system having multiple parameters, equations and rules (expert rules) derived by medical experts. Influencing factors for a specific patient are entered in to the expert system, and expert system calculates an estimated blood pressure range, heart rate range, or any other desired medical parameter range based on the influencing factors and the expert rules. These estimated ranges are used to set a maximum and minimum alarm value on a monitor. The system and method is further configured to include in the expert system an additional set of expert rules to calculate estimated ranges when the patient is under anesthetic.

In one aspect of the present invention, a system for estimating patient specific vital sign limits comprises a monitor configured to monitor a physiological parameter of a patient, an expert system including a storage medium and a processor, which is configured to be in communication with the monitor, and further configured with a first set of expert rules, and an input device, configured to enter a set of influencing factors into the expert system. The expert system is configured to calculate a first acceptable range for the physiological parameter using the first set of expert rules and the influencing factors, and sets a minimum alarm limit and a maximum alarm limit on the monitor according to the first acceptable range. The system further comprises an anesthetic delivery device configured to administer anesthetic to the patient, and further configured to communicate a target concentration of the anesthetic to the expert system. The expert system is configured to calculate the second acceptable range for the physiological parameter using the first acceptable range, a second set of expert rules the influencing factors and the target concentration, the expert system further configured to reset the minimum alarm limit and the maximum alarm limit according to the second acceptable range. The expert system is also either removably coupled to the monitor or permanently affixed to the monitor. The system's influencing factors includes any of the age, gender, weight, height, physical condition, medications or history of the patient.

A further aspect of the present invention is a method of estimating a patient's specific vital sign limits, entering a first set and a recent set of expert rules and a set of influencing factors into an expert system, calculating a first parameter range based on the first set of expert rules and the influencing factors, and setting a maximum and a minimum alarm value according to the first parameter range. The method further comprises entering a target concentration of the anesthetic into the expert system when a patient is under anesthetic and calculating a second parameter range based on the first parameter range, the second set of expert rules, the influencing factors and the target concentration of the anesthetic and resetting the maximum alarm value and the minimum alarm value according to the second parameter range.

### BRIEF DESCRIPTION OF THE DRAWINGS

FIG. 1 illustrates a schematic diagram according to an embodiment of the system of the present invention.

FIGS. 2a- 2b illustrates a block diagram according to an embodiment of the system of the present invention.

FIG. 3 illustrates a flow chart according to an embodiment of the method of the present invention.

### DETAILED DESCRIPTION OF THE INVENTION

The system and method estimates alarm limits for physiological monitors, using multiple parameters and rules from experts, such as anesthesiologists, that will alert the user to clinically significant changes in combinations of parameters. These “expert” rules, as expressed by experts in the medical field, sometimes involve phrases such as “blood pressure is low” or “heart rate is high,” “low” and “high” values are specific to a given patient as explained below. The monitored physiological parameters will be affected by anesthesia that is administered in surgery so the alarm system and method must adjust for this also.

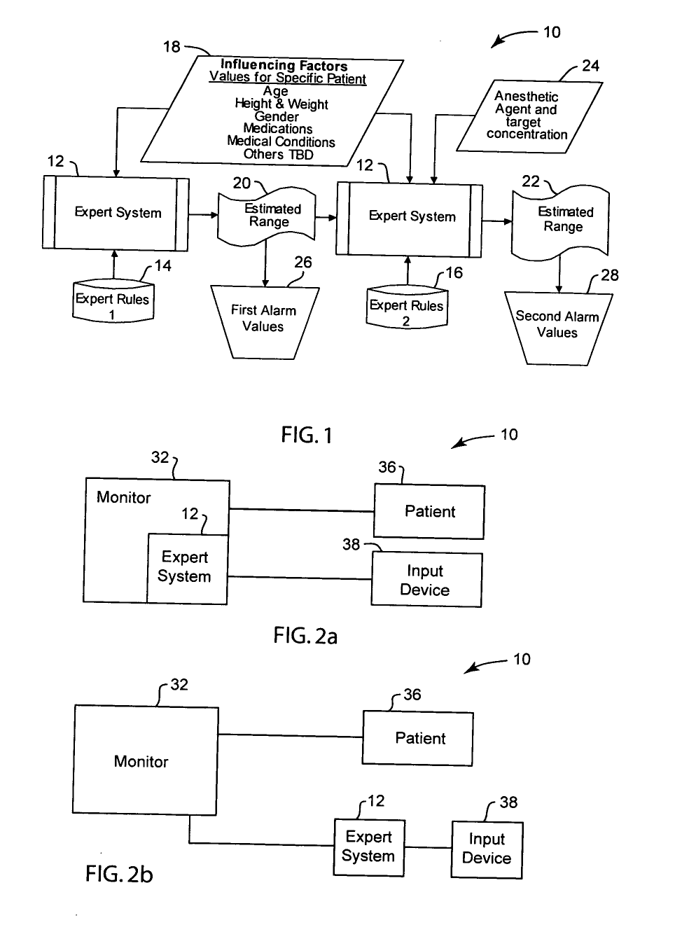

Referring to FIG. 1, the estimation system 10 includes an expert system 12 that incorporates the knowledge and rules used by expert anesthesiologists, as well as other medical experts. Specifically, anesthesiologists and other medical experts estimate expected and acceptable ranges of physiologic parameters for a specific patient during anesthesia/surgery based on known or published reference values and adjusting, compensating or applying rules for factors such as patient age, gender, height, weight, physical condition, medications, medical conditions/history, and anesthesia used. These reference values, with an expert system using an input the factors mentioned above, after applying expert's rules or calculations for adjusting them, are the basis of the invention.

Preferably, the system and method first estimates the parameter ranges without anesthesia, then applies additional rules to obtain estimates under anesthesia. Using just the non-anesthesia results makes the invention useful outside the operating theater such as in patient bedside monitoring and intensive care units. Furthermore, although blood pressure and heart rate are the vital signs of most interest to estimate, it is clear that this invention could as well estimate patient specific values of other physiologic variables.

Referring to FIG. 1, a schematic diagram according to an embodiment of the system of the present invention is depicted. Here, the expert system 12, which includes a storage medium and a processor, is used to estimate patient specific vital sign ranges, and alarm limits according to a number of inputs. The estimation system 10 includes inputting a first set of expert rules 14 into the expert system 12. As described previously, the first set of expert rules 14 are derived by experts in the field, such as anesthesiologists or other medical experts, and include a set of rules for determining acceptable ranges for medical parameters and how certain influencing factors 18 may affect those ranges. For example, the first set of expert rules may include a rule that an acceptable range for resting heart beat for a human is 40-140 bpm. The first set of expert rules may then include a rule that if the age of the patient is less than 10 years old, but greater than 1 year old, then the acceptable resting heart range is between 60 and 140 bpm. The first set of expert rules 14 could then include additional rules to further define this acceptable range of rest heart rate according to height and weight, gender, current prescriptions, medical conditions and many other influencing factors 18, which are also entered into the expert system 12 in order to estimate patient specific vital signs. Preferably, the first set of expert rules 14 are inputted into the expert system 12 prior to the estimation system 10 being implemented in a hospital.

Once again, the first set of expert rules 14 are entered into the expert system 12. Influencing factors 18 for a specific patient, such as but not limited to, age, height and weight, gender and existing medical conditions, are entered into the expert system 12. Preferably, the influencing factor 18 are entered automatically by a hospital information system (HIS), but manual entering has also been contemplated. The influencing factors 18 are compared against the expert rules 14 stored in the expert systems 12 storage medium, and a processor calculates a first estimated range 20 for a desired medical parameter. Returning to the previous example, for a 6 year old child with no other influencing factors 18 entered into the expert system 12, the first estimated range 20 for resting heart beat would be 60-140 bpm. The first estimated range 20 is then used to set a first set of alarm values 26, including a minimum alarm value, in the example 60 bpm, and a maximum resting heart beat level, in the example 140 bpm.

The estimation system 10 is further capable of estimating a second estimated range 22 for a desired medical parameter when the patient is under anesthetic. As described previously, the influencing factors 18 available to the user are entered into the expert system 12 by an HIS. Also, the first estimated range 20 is utilized in calculating this second estimated range 22. A second set of expert rules 16, which have also been previously entered into the expert system, and saved on the expert system's 12 storage medium, are utilized. As described above, this second set of expert rules 16 differs from the first set of expert rules 14, in that the second set of expert rules 16 are adjusted to reflect a patient that is under anesthetic. To return to the example above, perhaps a normal resting heart rate for a 6 year old child, under the second set of expert rules, is more in the range of 40-120 bpm. Also, a target concentration of the anesthetic 24 is also inputted to the expert system in order to calculate the second estimated range 22. Therefore, in calculating the second estimated range 22, the processor of the expert system 12 examines the first estimated range 20 in view of the influencing factors 18 and the target concentration of the anesthetic 24, and applies the second set of expert rules 16, in order to calculate a second estimated range 22. A second set of alarm values 28 is then derived from the second estimated range 22, including a minimum alarm value and a maximum alarm value.

Referring now to FIGS. 2a and 2b, the estimation system 10 is illustrated in block diagram. In FIG. 2a, the expert system 12 is physically incorporated within the monitor 32, and an input device 38, such as an HIS, for entering the influencing factors is coupled to the expert system 12 in the monitor 32. The patient 36 is continuously monitored by the monitor 32, while the expert system 12 is able to adjust the minimum and maximum alarm values for any desired physiological parameter on the monitor 32.

Referring now to FIG. 2b, the monitor 32, while monitoring a patient 36 is connected to an expert system 12, which is separate and removably coupled to the monitor 32. While the expert system 12 is not physically incorporated into the monitor 32 in this embodiment, the expert system 12 is in communication with the monitor 32 such that the expert system 12 may adjust the minimum and maximum alarm values of any desired physiological parameter of the monitor 32. Again, an input device 38 is coupled to the expert system 12, in order to input the influencing factors and target concentrations for anesthetics.

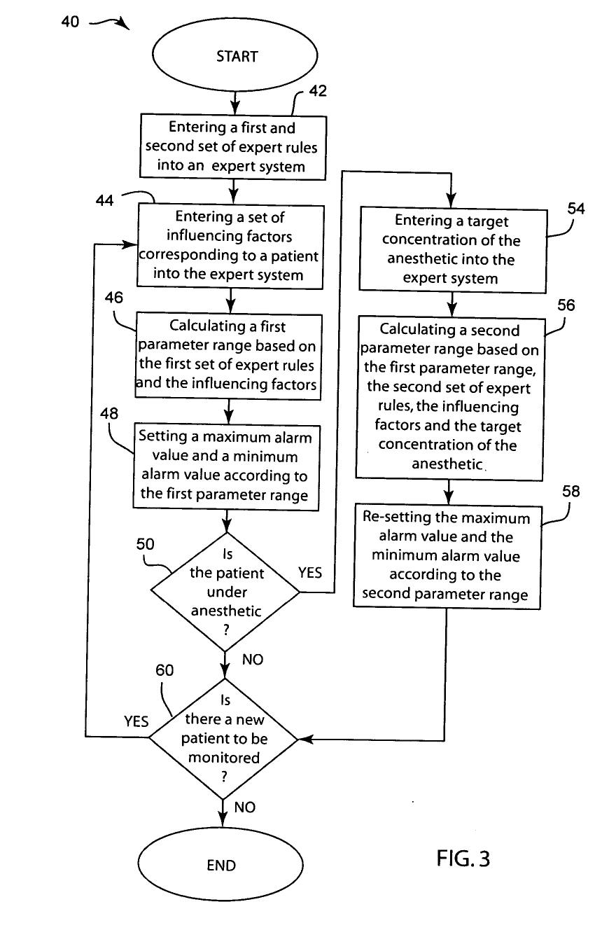

FIG. 3 illustrates an estimation method 40 of the present invention. In step 42 of the estimation method 40, a first and second set of expert rules are entered into the expert system. In step 44, a set of influencing factors corresponding to a specific patient are entered into the expert system. In step 46, a first parameter range is calculated based on the first set of expert rules and the influencing factors, and in step 48, a maximum alarm value and a minimum alarm value are set according to the first parameter range.

Still referring to the estimation method 40 in FIG. 3, it is determined in step 50 whether the patient is under anesthetic. If the patient is not under anesthetic, it is determined in step 60 whether a new patient needs to be monitored, thereby requiring a new estimation. If there are no new patients, then the method ends. If there is a new patient to be monitored in step 60, then the method returns to step 44.

Referring back to step 50, if the patient is under anesthetic then in step 54, a target concentration of the anesthetic is entered into the system, and in step 56 a second parameter range is calculated based on the first parameter range, the second set of expert rules, the influencing factors and the target concentration of the anesthetic. In step 58, the maximum alarm value and the minimum alarm value are reset according to the second parameter range. The estimation method 40 then continues on to step 60 where it is determined whether there is a new patient to be monitored.

As stated previously, a shortcoming of threshold based alarms used in prior art patient monitoring systems is that, because of the large variation of normal values between individual patients, the user must manually adjust high and low limits on a per patient basis in order to obtain maximum utility from the alarm system. Further, advanced multi-parameter “smart” alarms also need estimates of “high” and “low” parameter values in order to increase their accuracy. However, the user is often too busy to manually set these values on a per case basis. Thus, the usefulness of the alarm system is diminished for both the physician and the patient. The disclosed system and method saves physician the time taken to manually enter patient specific alarm limits, increases the utilization and quality of threshold based alarms, and provides input to “smart” multi-parameter alarms needed to increase their sensitivity and specificity.

The present invention has been described in terms of specific embodiments incorporating details to facilitate the understanding of the principles of the construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

I claim:

1. A system for estimating patient specific vital sign limits, the system comprising:
a monitor configured to monitor a physiological parameter of a patient;
an expert system including a storage medium and a processor, the expert system being configured to be in communication with the monitor, and further configured with a first set of expert rules; and
an input device, configured to enter a set of influencing factors into the expert system,
wherein the expert system is configured to calculate a first acceptable range for the physiological parameter using the first set of expert rules and the influencing factors, and sets a minimum alarm limit and a maximum alarm limit on the monitor according to the first acceptable range.

2. The system as claimed in claim 1, further comprising an anesthetic delivery device configured to administer anesthetic to the patient, and further configured to communicate a target concentration of the anesthetic to the expert system.

3. The system as claimed in claim 2, wherein the expert system is configured to calculate the second acceptable range for the physiological parameter using the first acceptable range, a second set of expert rules, the influencing factors and the target concentration, the expert system further configured to reset the minimum alarm limit and the maximum alarm limit according to the second acceptable range.

4. The system as claimed in claim 1, where the expert system is removably coupled to the monitor.

5. The system as claimed in claim 1, where the expert system is permanently affixed to the monitor.

6. The system as claimed in claim 1, where the influencing factors includes any of the age, gender, weight, height, physical condition, medications or history of the patient.

7. A method of estimating a patient's specific vital sign limits, the system comprising:
entering a first and a second set of expert rules and a set of influencing factors into an expert system;
calculating a first parameter range based on the first set of expert rules and the influencing factors; and
setting a maximum alarm value and a minimum alarm value according to the first parameter range.

8. The method as claimed in claim 7, further comprising entering a target concentration of the anesthetic into the expert system when a patient is under anesthetic.

9. The method as claimed in claim 8, further comprising calculating a second parameter range based on the first parameter range, the second set of expert rules, the influencing factors and the target concentration of the anesthetic.

10. The method as claimed in claim 9, further comprising resetting the maximum alarm value and the minimum alarm value according to the second parameter range.

11. The method as claimed in claim 7, wherein the expert system is removably coupled to a monitor.

12. The method as claimed in claim 7, wherein the expert system is permanently affixed to the monitor.

13. A system for estimating patient specific vital sign limits, the system comprising:
a monitor configured to monitor a physiological parameter of a patient;
an expert system including a storage medium and a processor, the expert system being configured to be in communication with the monitor;
an input device, such that user enters a first set of expert rules and a set of influencing factors into the expert system with the input device; and
an anesthetic delivery device configured to administer anesthetic to the patient, and further configured to communicate a target concentration of the anesthetic system,
wherein the expert system is configured to calculate a first acceptable range for the physiological parameter using the first set of expert rules and the influencing factors, and sets a minimum alarm limit and a maximum alarm limit on the monitor according to the first acceptable range,
and further wherein the expert system is configured to calculate the second acceptable range for the physiological parameter using the first acceptable rang, a second set of expert rules entered by the user, the influencing factors and the target concentration, the expert system further configured to reset the minimum alarm limit and the maximum alarm limit according to the second acceptable range.
